(19) United States
(12) Patent Application Publication
(10) Pub. No.: US 2013/0279503 A1
(43) Pub. Date: Oct. 24, 2013

(54) Next Hop Computation Functions for Equal Cost Multi-Path Packet Switching Networks

(71) Applicant: Rockstar Consortium US LP, Plano, TX (US)

(72) Inventor: Jerome Chiabaut, Ottawa (CA)

(21) Appl. No.: 13/914,680

(22) Filed: Jun. 11, 2013

Related U.S. Application Data
(63) Continuation of application No. PCT/US2012/025552, filed on Feb. 17, 2012.

(51) Int. Cl. H04L 12/56

(52) U.S. Cl. CPC H04L 45/44
USPC 370/389

(57) ABSTRACT

Next hop computation functions for use in a per-node ECMP path determination algorithm are provided, which increase traffic spreading between network resources in an equal cost multi-path packet switch network. In one embodiment, packets are mapped to output ports by causing each ECMP node on the network to implement an entropy preserving mapping function keyed with unique key material. The unique key material enables each node to instantiate a respective mapping function from a common function prototype such that a given input will map to a different output on different nodes. Where an output set of the mapping function is larger than the number of candidate output ports, a compression function is used to convert the keyed output of the mapping function to the candidate set of ECMP ports.

### CROSS REFERENCE TO RELATED APPLICATIONS

This application is a continuation of international application PCT/US2012/025552, filed Feb. 17, 2012, which claims the benefit of U.S. Provisional Application No. 61/443,993, filed Feb. 17, 2011, entitled “Next Hop Computation Functions For Equal Cost Multi-Path Packet Switch Networks,” the content of each of which is hereby incorporated herein by reference.

### TECHNICAL FIELD

The present invention relates to packet switched networks, and in particular to next hop computation functions for equal cost paths in packet switched networks.

### BACKGROUND

In Ethernet network architectures, devices connected to the network compete for the ability to use shared telecommunications paths at any given time. Where multiple bridges or nodes are used to interconnect network segments, multiple potential paths to the same destination often exist. The benefit of this architecture is that it provides path redundancy between bridges and permits capacity to be added to the network in the form of additional links. However to prevent loops from being formed, a spanning tree was generally used to restrict the manner in which traffic was broadcast on the network. Since routes were learned by broadcasting a frame and waiting for a response, and since both the request and response would follow the spanning tree, most if not all of the traffic would follow the links that were part of the spanning tree. This often led to over-utilization of the links that were on the spanning tree and non-utilization of the links that weren't part of the spanning tree. Spanning trees may be used in other forms of packet switched networks as well.

To overcome some of the limitations inherent in networks controlled using a spanning tree, a link state protocol control plane can be used to control operation of the nodes in the packet network. Using a link state protocol to control a packet network enables more efficient use of network capacity with loop-free shortest path forwarding. Rather than utilizing the Spanning Tree Protocol (STP) algorithm combined with transparent bridging, in a link state protocol controlled packet network the bridges forming the mesh network exchange link state advertisements to enable each node to have a synchronized view of the network topology.

This is achieved via the well understood mechanism of a link state routing system. Two examples of link state routing protocols include Open Shortest Path First (OSPF) and Intermediate System to Intermediate System (IS-IS), although other link state routing protocols may be used as well. In a link state routing system, the bridges in the network have a synchronized view of the network topology, have knowledge of the requisite unicast and multicast connectivity, can compute a shortest path connectivity between any pair of bridges in the network, and individually can populate their forwarding information bases (FIBs) according to shortest paths computed based on a common view of the network.

Link state protocol controlled packet networks provide the equivalent of Ethernet bridged connectivity, but achieve this via configuration of the network element FIBs rather than by flooding and learning. When all nodes have computed their role in the synchronized network view and populated their FIBs, the network will have a loop-free unicast tree to any given bridge from the set of peer bridges, and a congruent, loop-free, point-to-multipoint (p2mp) multicast tree from any given bridge to the same set of peer bridges per service instance hosted at the bridge. The result is the path between a given bridge pair is not constrained to transiting the root bridge of a spanning tree and the overall result can better utilize the breadth of connectivity of a mesh. The Institute of Electrical and Electronics Engineers (IEEE) standard 802.1aq specifies one implementation of this technology.

There are instances where multiple equal cost paths exist between nodes in a network. Particularly in a data center, where there is a very dense mesh of interconnected switches, there may be multiple equal cost paths between a source and a destination or between intermediate nodes along the path between the source and destination. Where there are multiple equal cost paths between a pair of nodes, it may be desirable to distribute traffic between the available paths to obtain better utilization of network resources and/or for better network throughput. Equal Cost Multi-Path (ECMP) routing is the process of forwarding packets through a packet switching network so as to distribute traffic among multiple available substantially equal cost paths.

ECMP routing may be implemented at a head-end node, as traffic enters the network, or may be implemented in a distributed fashion at each node in the network. When ECMP routing is implemented in a distributed manner, each node that has multiple equal cost paths to a destination will locally direct different flows of traffic over the multiple available paths to distribute traffic on the network. Unfortunately, optimal usage of the network capacity when distributed per-node ECMP is implemented is difficult to achieve.

For example, FIG. 1 shows a typical traffic distribution pattern in an packet network, in which each node on the network uses the same ECMP computation function to select from available paths. In the example shown in FIG. 1, traffic intended for one of switches I-L may arrive at any of switches A-D. The goal is to spread the traffic out on the network such that a large number of paths are used to forward traffic through the network. Unfortunately, as shown in FIG. 1, the use of the same next hop computation function on every node can result in very poor traffic distribution in some areas of the network. In particular, regularities or patterns in flow IDs may cause traffic to become concentrated and result in insufficient traffic spreading between available paths on the network.

### SUMMARY OF THE INVENTION

The following Summary and the Abstract set forth at the end of this application are provided herein to introduce some concepts discussed in the Detailed Description below. The Summary and Abstract sections are not comprehensive and are not intended to delineate the scope of protectable subject matter which is set forth by the claims presented below.

Next hop computation functions for use in a per-node ECMP path determination algorithm are provided, which increase traffic spreading between network resources in an equal cost multi-path packet switch network. In one embodiment, packets are mapped to output ports by causing each ECMP node on the network to implement an entropy preserving mapping function keyed with unique key material. The unique key material enables each node to instantiate a respective mapping function from a common function prototype such that a given input will map to a different output on different nodes. Where an output set of the mapping function is larger than the number of candidate output ports, a compression function is used to convert the keyed output of the mapping function to the candidate set of ECMP ports.

### BRIEF DESCRIPTION OF THE DRAWINGS

Aspects of the present invention are pointed out with particularity in the appended claims. The present invention is illustrated by way of example in the following drawings in which like references indicate similar elements. The following drawings disclose various embodiments of the present invention for purposes of illustration only and are not intended to limit the scope of the invention. For purposes of clarity, not every component may be labeled in every figure. In the figures:

FIGS. 1 and 2 are functional block diagrams of example packet switching networks;

FIGS. 3A-3B show example application of different mappings at nodes to implement ECMP routing;

FIG. 4 is a functional block diagram of an example network element; and

FIG. 5 is a flow chart illustrating a process that may be used to implement ECMP routing.

### DETAILED DESCRIPTION

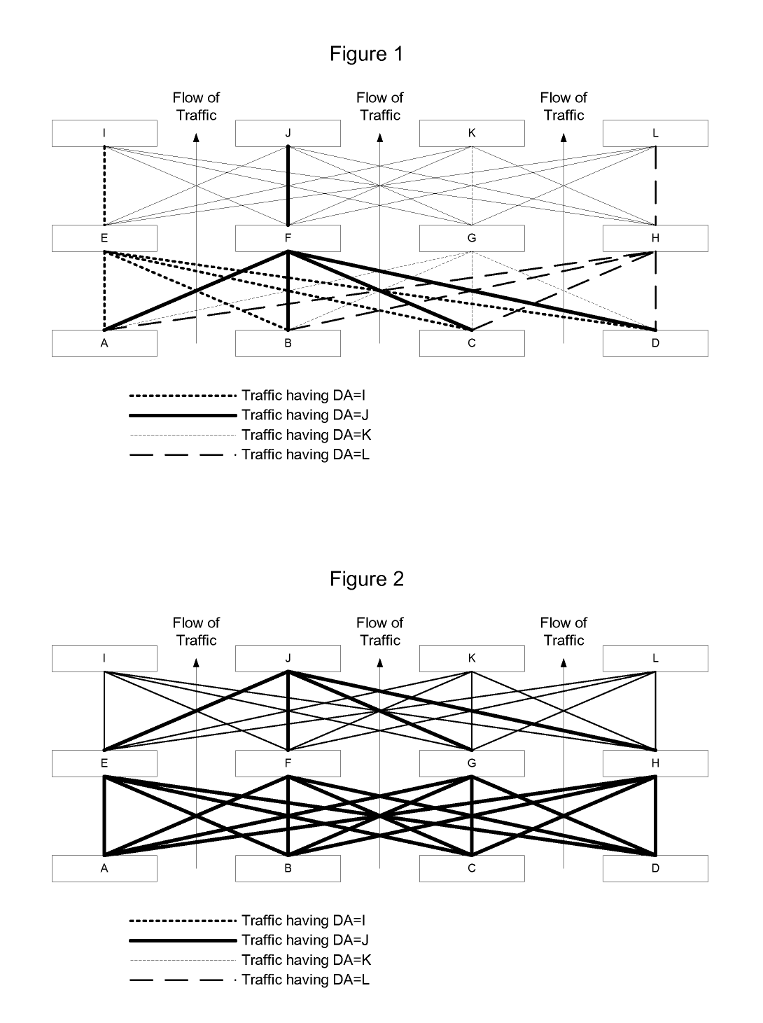

FIG. 1 shows a sample network in which the same next hop computation function is used at every hop in the network. The traffic flows from the bottom to the top of FIG. 1 and at each node the traffic is locally mapped by the node to one of 4 possible output ports. Between the bottom and the middle rows of switches the traffic is evenly distributed, with each link of the mesh connecting the two rows being utilized. The middle row of switches, however, is unable to make use of all the links that connect it to the top row. The leftmost switch in the middle row only received traffic that is mapped to a leftmost outgoing port. Similarly, the i^{th} switch in the row only receives traffic that is mapped to the i^{th} port in the preceding stage. This pathological behavior is caused by the use of the same mapping function at each node and by the regular nature of the mesh used in this example. However, this type of very regular network structure is not at all uncommon. In particular, data centers tend to use regular structures like the one shown in FIG. 1 in which rows of switches are interconnected by very regular meshes.

FIG. 2 shows the network of FIG. 1, in which an alternative ECMP path selection process has been implemented to distribute traffic more evenly on the network between the available links. For simplicity, only traffic having a DA=J is shown in FIG. 2. In this example, traffic may arrive at any of nodes A, B, C, and D. Each of these nodes may select a link connecting to any of nodes E, F, G, and H. That node then forwards traffic on to node J. By comparing FIG. 2 with FIG. 1, it is apparent that traffic is much more evenly distributed on the links interconnecting both tiers of nodes. Traffic patterns such as the Example shown in FIG. 2 are easier to achieve in a distributed ECMP system when nodes on the network use different ECMP path selection algorithms. Specifically, the use of independent next hop selection algorithms reduces the likelihood that the patterns associated with path IDs will have a strong correlation on path selection, thus causing a more widespread distribution of traffic on the network.

To implement traffic spreading, for example as shown in FIG. 2, a distributed ECMP process is used in which each node of the packet switching network must determine, for each packet it receives on an input port, an appropriate output port on which to output the packet for transmission to a next node on a path through the network toward the destination. To implement ECMP, each node must make appropriate forwarding determinations for the received packets. To achieve traffic spreading, the algorithm used by the nodes must be somewhat randomized. However, to enable network traffic to be simulated and predicted, the algorithms should be deterministic. Further, packets associated with individual flows should consistently be allocated to the same output port, to enable flows of packets to be directed out the same port toward the intended destination.

According to an embodiment, permutations are used to distribute traffic at each node of the network. The permutations are created using algorithms which are deterministic, so that the manner in which a particular flow of traffic will be routed through the network may be predicted in advance. However, the permutations are designed in such a manner to allow good traffic spreading between available links with pseudo-random output behavior given small differences in input stimulus. Further, the selected algorithm is designed such that each node on the network will use the same algorithm in connection with a locally unique key value to enable an essentially locally unique function to be used to select ECMP next hops. Although an embodiment will be described which is focused on layer 2 (Ethernet) switching of traffic in a packet network, the techniques described for implementing traffic spreading may also be useful in layer 3 networks using ECMP routing.

In one embodiment, each packet received at an ingress port of an ingress switch is assigned a Flow Identifier (Flow ID). Typically, flow IDs may be based on information in a customer MAC header (C-MAC) or in an Internet Protocol (IP) header, such as IP Source Address (SA), IP Destination Address (DA), protocol identifier, source and destination ports and possibly other content of a header of the packet. Alternatively a Flow ID could be assigned to a packet in another manner. For instance, a management system may assign Flow IDs to management packets to monitor the health and performance of specific network paths. The Flow ID is encapsulated in a packet header at the ingress switch and may be decapsulated from the packet header at the egress switch. The Flow ID could be carried in the 12-bit VLAN identifier (B-VID) field, in the 24-bit Service identifier (I-SID) field, in a new (as yet unspecified) field or in any part or combination of these fields. Multiple ways of implementing creation, dissemination, and/or recreation of the flow ID may be implemented, depending on the particular implementation.

There are several protocols which require packets having the same Flow ID to be forwarded from the same ingress switch to the same egress switch via the same intermediate switches—i.e. via the same path through the network. Having packets transmitted in this manner prevents out-of-order reception of packets and otherwise facilitates transmission of data on the network. Hence, where nodes perform ECMP, the algorithm implemented at the node to select between equal cost paths to the destination should operate consistently (i.e. always select the same output path) for packets associated with a given flow ID.

However, for an ECMP network, packets having different Flow IDs that require forwarding from the same ingress switch to the same egress switch should be distributed, according to their Flow IDs, among different equal cost paths between the ingress switch and the egress switch where there are multiple substantially equal cost paths between the ingress switch and the egress switch to choose from.

According to an embodiment, to achieve this distribution of packets having different Flow IDs among substantially equal cost paths, each switch in the network determines the appropriate output port for a received packet carrying a particular DA and a particular Flow ID by:
1. Mapping the DA onto a set of candidate output ports corresponding to a set of least cost paths to the DA. Where there is only one least cost path, there will be only one candidate output port. Where there are multiple substantially equal cost least cost paths to the DA, there may be multiple candidate output ports.
2. At least where the DA corresponds to multiple candidate output ports, mapping the Flow ID to one of the candidate output ports using a mapping function which is keyed to the particular switch. The mappings should be such that, at each switch, the distributions of Flow IDs to output ports will be roughly evenly distributed. Note that this step is not required for packets having DAs for which there is only one corresponding candidate output port—the packet may simply be routed to that output port.

According to an embodiment, the mapping of Flow IDs to candidate output ports at a node may be produced by combining an entropy-preserving pseudo-random mapping (i.e. the number of distinct outputs of the mapping should equal the number of distinct inputs) with a compression function that maps a large number of mapped Flow IDs to a small number of candidate output ports. This entropy-preserving mapping may be a bijective function in which the set of distinct inputs is mapped to a set of distinct outputs having the same number of elements as the set of distinct inputs. Alternatively, the entropy-preserving mapping may comprise an injective function in which the set of distinct inputs is mapped to a larger set of possible distinct outputs in which only a number of distinct outputs corresponding to the number of distinct inputs are used. In either alternative, the mapping of distinct inputs to distinct outputs is one-to-one.

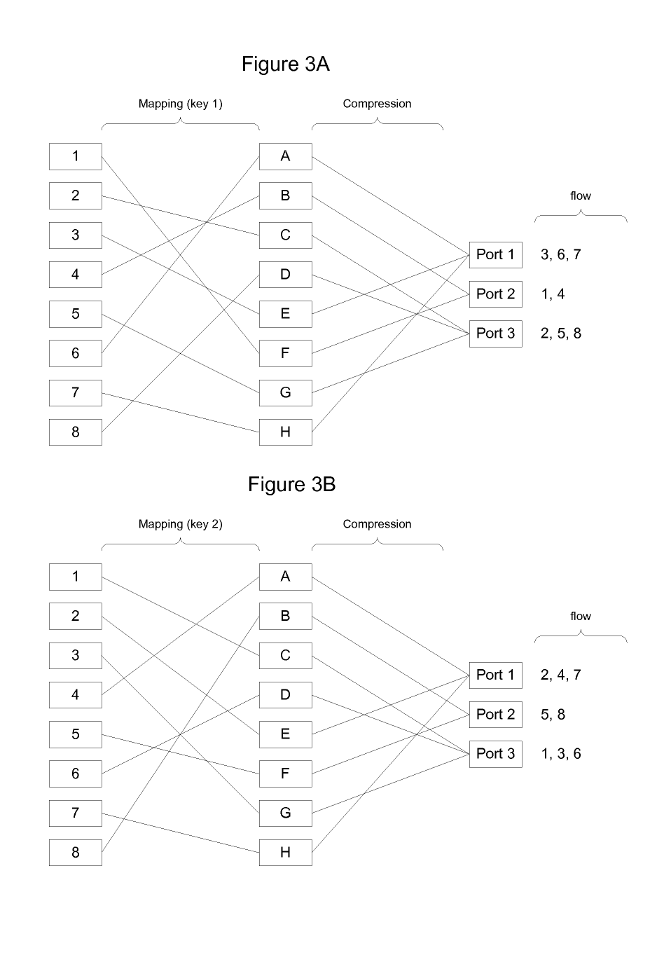

FIGS. 3A and 3B show an example mapping of eight inputs (1-8) to eight outputs (A-H). As shown in FIG. 3A, there are many ways to map inputs to outputs. According to an embodiment, each node uses a mapping function to map flow identifiers to a candidate set of outputs. This, in effect, creates a shuffled sequence of flow IDs. Mapping the flow identifiers in this manner randomizes the flow identifiers to reduce or eliminate any patterns associated with assignment of flow identifiers to flows on the network. In one embodiment, each node takes a prototype mapping and applies a key value to the mapping, to instantiate a unique mapping at the node. For example, each node may use the value of the key in a multiplication function to produce a cyclic shift of the shuffled sequence of flow IDs which is unique at the node. FIG. 3A shows the mapping of inputs 1-8 to outputs A-H using a first mapping derived from a prototype mapping using a first key, and FIG. 3B shows the mapping of inputs 1-8 to outputs A-H using a second mapping derived from the same prototype using a second key. As shown in the comparison of FIGS. 3A and 3B, the use of different keys causes different input values (flow IDs) to be mapped to different output values.

To prevent traffic aggregation and flow concentration, according to an embodiment, the mappings should be such that no two switches have the same entropy-preserving mapping. This can be arranged by assigning a unique key to each switch and mapping the Flow IDs using a keyed mapping function which is unique to each switch. Since the key is different at each switch, and because the underlying algorithm used by the switch to perform the mapping is completely specified by the key and the prototype entropy-preserving mapping function, the keyed mapping function will be unique to the switch. This enables the flows of traffic on the network to be determined, while also allowing a mapping of a particular flow ID to a set of output ports to be different at each switch on the network due to the different key in use at each switch.

It may be expected that the number of possible flow IDs may greatly exceed the number of ECMP paths on the network. For example, if the flow ID is 12 bits long, it would be expected that there would be on the order of 4096 possible flow IDs which may be assigned to flows on the network and which will be mapped using the mapping function to a different set of 4096 values. However, it is unlikely that there will be 4096 equal cost paths to a given destination. Accordingly, since the entropy-preserving mapping function produces a larger number of outputs than the number of candidate output ports, the mapping further comprises a compression function to compress the number of distinct outputs to equal the number of candidate output ports. The compression function should be such as to preserve the pseudo-randomness of the prototype mapping. Since the entropy-preserving mapping function at each node is at least partially based on a value associated with that node, use of a standard compression function common to all the nodes will maintain the link distribution randomization associated with use of the entropy-preserving mapping function.

FIGS. 3A and 3B show an example in which the same compression function is used to map each of the outputs of the mapping A-H to a set of three output ports. As shown in FIGS. 3A and 3B, outputs A, E, and H of the mapping function are compressed to port 1, outputs B, and F of the mapping function are compressed to port 2, and outputs C, D, and G of the mapping function are compressed to port 3. Thus, in both FIGS. 3A and 3B, the same compression has been used to reduce the set of output values to a candidate set of output ports. However, because of the entropy introduced during the mapping, the use of a common compression function allows a different set of inputs (1-8) to be mapped to each of the output ports. Specifically, as shown in FIG. 3A, the key (key 1) included by a first node in its execution of the mapping function causes input flows 3, 6, and 7 to be mapped to port 1, flows 1 and 4 to be mapped to port 2, and flows 2, 5, and 8 to be mapped to port 3. In FIG. 3B, a different key, key 2, is used and flows 2, 4, and 7 are mapped to port 1, flows 5 and 8 are mapped to port 2, and flows 1, 3, and 6 are mapped to port 3. As is shown in these figures, use of a common compression function allows entropy introduced in the mapping to be preserved in connection with output port selection, so that multiple nodes on the network may use a common compression function.

Example mappings are described in greater detail below. In the following description, x denotes the Flow ID, f denotes a prototype mapping, n denotes a switch key, fₙ denotes a keyed mapping, and fₙ(x) denotes a mapped Flow-ID prior to application of the compression function. Application of the compression function to the mapped Flow ID determines which output port, among the output port candidates, is used for forwarding the packet.

Preferably, a candidate prototype mapping should be constructed such that any pair of switches that use different keys will instantiate entropy-preserving mappings that won't map any flow IDs to a same value. According to one embodiment, exponential-based mappings are used to randomize flow IDs to disrupt patterns that may be present in the flow IDs. Although other mappings may also be used, the use of exponential-based mappings provide adequate results for many applications. Likewise, it may be possible to combine several mappings, each of which has a desired property, to obtain a combined function exhibiting a set of desired characteristics. Accordingly, different embodiments may be constructed using different mappings (i.e. by combining multiple entropy-preserving prototype mapping functions) to achieve deterministic traffic spreading on equal cost links in an ECMP network.

There are many possible globally unique values that the nodes may use as keys to instantiate local mappings. For example, switches may use an IS-IS switch ID, an Shortest Path Bridging MAC (SPBM) Source ID (B-SA), or any other combination of values or a transformation/combination of these values that preserves uniqueness. These values may be used as keys for the node mapping function, to enable each mapping function to be unique to the particular switch in the network. However, the prototype mapping function, i.e. the algorithm used, is the same at all nodes so that the actual mapping function used at a given node is completely specified by the key value in use at that node. Although an example was provided in which key material is determined based on properties inherent at the node, i.e. the node ID, in another embodiment the ECMP key material may be a programmed value provided by a management system, randomly generated on the switches, or derived from unique identifiers (e.g. a hash of system ID or the SPBM SPSourceID). Additionally, in applications where it is deemed important to not have any nodes on the network utilizing the same key material, the nodes may advertise the key material using the link state routing system to enable each node to learn the keys in use at other nodes and to ensure that each other node within the routing area is using unique key material.

Although it is theoretically desirable, the uniqueness of the keys is not absolutely necessary. For example, from a practical standpoint, the method will perform adequately as long as the chances that two switches will use the same keys are kept relatively low.

Example Algorithms:

In the following discussion, it will be assumed that flow IDs will be small integers, probably no more than 24 bits and most likely 8 or 16 bits. The permutation size will be a power of 2 (e.g. 2⁸, 2¹⁶) or close to it. Each switch will be assigned a unique pseudo-random permutation or pseudo-permutation. In connection with this, it is important to avoid a pathological case of two switches in a path using the same mappings. A switch mapping function is constructed by keying a generic function with a small (<64 bits) unique (with high probability) integer. A compression function, which may be the same on all switches, may also be used. The combination of the use of a same prototype entropy-preserving function at all switches and the same compression function at all switches would make network behavior completely predictable, provided knowledge of the keys and that a convention is adopted for link numbering (e.g. order the ECMP candidate output ports according to their respective links' endpoint bridge identifiers).

By causing the nodes on the network to use the same function and the same compression process, it is possible to determine how a flow will be routed through the network (assuming knowledge of the key material used at each node to instantiate the entropy-preserving mapping function at that node). This allows prediction of data traffic patterns through modeling, rather than requiring traffic patterns to be learned by measurement. The goal, therefore, is to find functions that behave sufficiently randomly to distribute traffic across a broad range of equal cost links, without using actual randomness to preserve the ability to model traffic behavior on the network.

According to an embodiment, switches should use different entropy preserving mappings, such as a permutation or injection, such that any two mappings in the family should be sufficiently de-correlated. In one embodiment the mapping function used to map an input set to an output set is injective: that is any two different inputs are mapped to different outputs. Additionally, the entropy-preserving prototype mapping function should have the desirable property that two instantiations of the mapping function using different random key material will result in different mappings which are not directly correlated with each other in a meaningful/obvious manner.

In a preferred embodiment two different instantiations of the entropy-preserving mapping function should not map the same flow ID should to a same value in different switches. Likewise, a mapping should be identifiable/keyed by a small unique identifier that optionally may be advertised by the routing system, e.g. via IS-IS. This could be an IS-IS system ID, a Shortest Path Bridging MAC Source ID (SPBM SPSourceID), a new unique identifier, or any combination of these that preserves uniqueness. Alternatively, the key could be provisioned, randomly generated, or derived from unique identifiers such as the hash of the system ID. The mapping should also appear pseudo-random when followed by a simple compression function. This is especially important for small numbers of candidate output ports.

Permutations based on linear-congruential mappings were found to produce simple entropy-preserving mappings such that two different mappings keyed from a common prototype never map a same input to a same output. Linear-congruential random number generation works by computing successive random numbers from the previous random number. An example linear congruential mapping function may be implemented using xᵢ₊₁=(Axᵢ+C) MOD M, in which C and M are relatively prime.

However, some of these simple mappings exhibit characteristics which, when MOD was used as a compression function, exhibited properties that were far from random, particularly for small multipliers. Stronger pseudo-random permutations based on modular exponentiation, by contrast, exhibited better performance. For example, applying a pseudo-random permutation of the shuffled flow IDs, in which the flow IDs were shuffled using a simple permutation, caused a more random looking shuffle to be created. Likewise, it is possible to shuffle the flow IDs using a good pseudo random function such as a modular exponentiation and, at each node, start at a different offset in the shuffled sequence. More complex entropy-preserving mappings may also be constructed by combining elementary mappings with desirable properties. For instance, combinations of linear-congruential mappings and modular-exponential mappings were found to exhibit the good properties of both: the resulting mappings exhibit the good pseudo-randomness properties of the modular exponential mappings as well as the uniqueness property of the linear-congruential mappings.

For example, given a prime p, and a primitive root g, the function f(x)=g^{x} mod p is a one-to-one mapping of any consecutive p−1 integers (i.e. x . . . x+p−2) to the range 1 . . . p−1. In particular, it generates a pseudo-random permutation of the integers 1 . . . p−1. Similarly, the function h(x)=(g^{x} mod p)−1 generates a pseudo-random permutation of the integers 0 . . . p−2. Modular exponentiation can therefore be used to randomize the shuffled flow IDs. Alternatively, modular exponentiation can be used to construct a more random shuffle in which the modular exponentiation itself is keyed at each node. For instance, a different primitive root could be used at each node. This is easily accomplished by generating a node-specific primitive root as a suitably chosen power of a common base root.

Table I (below) was created using exponentiation, where fn(x)=3̂[(2n+1)x+n mod 2^{m}] mod(2^{m}+1)−1. Note that 3^{x} mod 17 maps 0 . . . 15 (or 1.16) to 1 . . . 16. Remapping 1 . . . 16 to 0 . . . 15 is not absolutely necessary but can be done in many ways (e.g. x→x mod 16, x→16−x, etc) and does not alter the properties of the underlying permutations.

TABLE 1

| x | 0 | 1 | 2 | 3 | 4 | 5 | 6 | 7 | 8 | 9 | 10 | 11 | 12 | 13 | 14 | 15 |
|---|---|---|---|---|---|---|---|---|---|---|---|---|---|---|---|---|
| f₀(x) | 0 | 2 | 8 | 9 | 12 | 4 | 14 | 10 | 15 | 13 | 7 | 6 | 3 | 11 | 1 | 5 |
| f₁(x) | 2 | 12 | 10 | 7 | 11 | 0 | 9 | 14 | 13 | 3 | 5 | 8 | 4 | 15 | 6 | 1 |
| f₂(x) | 8 | 10 | 3 | 2 | 14 | 6 | 0 | 4 | 7 | 5 | 12 | 13 | 1 | 9 | 15 | 11 |
| f₃(x) | 9 | 7 | 2 | 15 | 5 | 14 | 11 | 12 | 6 | 8 | 13 | 0 | 10 | 1 | 4 | 3 |
| f₄(x) | 12 | 11 | 14 | 5 | 15 | 2 | 7 | 9 | 3 | 4 | 1 | 10 | 0 | 13 | 8 | 6 |
| f₅(x) | 4 | 0 | 6 | 14 | 2 | 3 | 10 | 8 | 11 | 15 | 9 | 1 | 13 | 12 | 5 | 7 |
| f₆(x) | 14 | 9 | 0 | 11 | 7 | 10 | 12 | 2 | 1 | 6 | 15 | 4 | 8 | 5 | 3 | 13 |
| f₇(x) | 10 | 14 | 4 | 12 | 9 | 8 | 2 | 0 | 5 | 1 | 11 | 3 | 6 | 7 | 13 | 15 |

If the flow ID is 8 or 16 bits, the corresponding Fermat primes (F₃=257, F₄=65537) and a suitable primitive root (e.g. 3) can be used for modular exponentiation. Fermat primes, in number theory, are primes, in which Fₚ=2^{2p}+1 (p=0 . . . 4). It is then straightforward to map the resulting range 1 . . . Fₚ−1 back to 0 . . . Fₚ−2 to produce a proper permutation if so desired.

If the flow ID is a different number of bits, then the next higher (or next smaller) prime can be used instead. If the prime selected for the permutation is slightly smaller than the number of flow IDs, the resulting mapping will be lossy and not entirely entropy-preserving. If the prime is larger than the number of flow IDs, at least one extra bit will be required to represent the values produced unless the resulting sequence is renumbered to account for the fact that the images of the integers greater than the largest flow ID can't be reached. For example, if the flow ID is 12 bits long (m=12) then 2^{m}=4096 and the closest larger prime to 4096 is p=4099. 4096, 4097, and 4098 are not in the input set, and therefore their images are not in the output.

2̂4098 mod 4099=1

2̂4097 mod 4099=2̂4098/2 mod 4099=(1+4099)/2=2050

2̂4096 mod 4099=2050/2=1025

let f(x) be the function defined for 0≦x≦4095.

y=2̂x mod 4099

if (y<1025) then f(x)=y−2;

else if (1025<y<2050) then f(x)=y−3

else f(x)=y−4

The above function generates a permutation of the integers 0 . . . 4095.

In table 1, a simple linear-congruential shuffle x→(2n+1)x+n mod 2^{m} was combined with a modular exponentiation y→3^{y} mod 2^{m}+1 to produce a prototype mapping that combines the desirable properties of both. Table 2 shows another example, in which fₙ(x)=[((9n mod 2^{m})+1)*(3^{3x} mod(2^{m}+1))−1] mod(2^{m}+1):

TABLE 2

| x | 0 | 1 | 2 | 3 | 4 | 5 | 6 | 7 | 8 | 9 | 10 | 11 | 12 | 13 | 14 | 15 |
|---|---|---|---|---|---|---|---|---|---|---|---|---|---|---|---|---|
| f₀(x) | 0 | 2 | 8 | 9 | 12 | 4 | 14 | 10 | 15 | 13 | 7 | 6 | 3 | 11 | 1 | 5 |
| f₁(x) | 9 | 12 | 4 | 14 | 10 | 15 | 13 | 7 | 6 | 3 | 11 | 1 | 5 | 0 | 2 | 8 |
| f₂(x) | 2 | 8 | 9 | 12 | 4 | 14 | 10 | 15 | 13 | 7 | 6 | 3 | 11 | 1 | 5 | 0 |
| f₃(x) | 11 | 1 | 5 | 0 | 2 | 8 | 9 | 12 | 4 | 14 | 10 | 15 | 13 | 7 | 6 | 3 |
| f₄(x) | 4 | 14 | 10 | 15 | 13 | 7 | 6 | 3 | 11 | 1 | 5 | 0 | 2 | 8 | 9 | 12 |
| f₅(x) | 13 | 7 | 6 | 3 | 11 | 1 | 5 | 0 | 2 | 8 | 9 | 12 | 4 | 14 | 10 | 15 |
| f₆(x) | 6 | 3 | 11 | 1 | 5 | 0 | 2 | 8 | 9 | 12 | 4 | 14 | 10 | 15 | 13 | 7 |
| f₇(x) | 15 | 13 | 7 | 6 | 3 | 11 | 1 | 5 | 0 | 2 | 8 | 9 | 12 | 4 | 14 | 10 |

In this case, a modular exponentiation is applied first followed by a keyed linear-congruential shuffle. The multiplication by a non-zero multiplier of the sequence produced by the modular exponentiation produces a cyclic shift of the sequence.

Note that any primitive root can be expressed as a power of any other primitive root with a suitably chosen exponent. In the example shown in Table 2 the primitive root used as the basis for exponentiation was 3³=27.

The permutation described above causes a shuffling of input numbers to output numbers which may be used to shuffle flow IDs at each switch on the network. Each switch then takes the shuffled flow IDs and uses its key to further shuffle the flow IDs in a manner unique to the switch. For example, each switch can use its key such that multiplication of the shuffled sequence of flow IDs by a non-zero function of the key produces a cyclic shift of the sequence. Alternatively, the keying material can be used to select a different primitive root that will be used as the basis for a modular exponentiation at each switch. Other ways of using the key material may be implemented as well.

Although the above description was provided in connection with examples in which the permutations were described using one-line notation, other notations such as, for instance, cycle notation, may be used to express the permutations. In particular, cycle notation provides a convenient way to visualize what happens when a family of permutations is generated by the powers of a base permutation.

An arbitrary power of a permutation can be computed very efficiently by using a cycle notation of the permutation in which each element is followed by its image through the permutation (with the convention that the last element in the cycle-notation sequence maps back to the first element in the sequence). In the cycle notation, taking a power, s, of a permutation amounts to skipping ahead s elements in the cycle notation. Conversion between one line and cycle notations is easy. It is possible to start from the cycle notation of the permutation as this guarantees that the order of the permutation will be equal to the number of elements in the permutation.

Here we illustrate this process using the example permutation based on the closed form equation f(x)=(2x+1) mod 11 or equivalently on the recurrence c(0)=1, c(x+1)=c(x)+2 mod 11. This defines a permutation of the 10 digits. The cycle notation for this permutation is (0 1 3 7 4 9 8 6 2 5) and the one line notation is (1 3 5 7 9 0 2 4 6 8). The one-line notation shows the effect of the permutation on an ordered sequence whereas the cycle notation shows the cycle through which each element goes as the permutation is applied repeatedly. More succinctly one-line and cycle notations can be summarized as:
One-line[x]=f(x)
Cycle[n+1]=f(Cycle[n]) with Cycle[0] an arbitrarily chosen one of the elements being permuted

To convert between one-line notation and cycle notation is easy: pick an arbitrary element to be the first in the cycle notation (e.g. 0) and then for each remaining element in the cycle, use the one-line notation to lookup the image of it predecessor in the sequence:
Cycle[0]=0;
Cycle[n+1]=One-line[Cycle[n]] for n=1 to N

In the reverse direction, to convert between cycle notation and one-line notation is equally easy:
One-line[Cycle[n]]=Cycle[n+1].

Similarly, the one-line notation of a power, s, of permutation is given by its cycle notation:
One-line[Cycle[n]]=Cycle[n+s]
   where care should be taken to implement the wrap-around at the end of the cycle (i.e. the indexing is taken modulo the length of the Cycle).

Thus, if the one-line or cycle representation of a permutation is given, then a one-line or cycle representation of an arbitrary power of the permutation can be computed. Table 3 shows the successive powers of the example permutation based on the equation f(x)=(2x+1) mod 11. The top row (row 0) corresponds to the zero^{th} power of the permutation, row 1 show the one-line notation of the permutation, and more generally row n shows the one-line notation of the nth power of the permutation. The columns in the table (except the left-most one which shows the successive powers) correspond to the different cycle notations of the base permutation.

TABLE 3

| 0 | 0 | 1 | 2 | 3 | 4 | 5 | 6 | 7 | 8 | 9 |
|---|---|---|---|---|---|---|---|---|---|---|
| 1 | 1 | 3 | 5 | 7 | 9 | 0 | 2 | 4 | 6 | 8 |
| 2 | 3 | 7 | 0 | 4 | 8 | 1 | 5 | 9 | 2 | 6 |
| 3 | 7 | 4 | 1 | 9 | 6 | 3 | 0 | 8 | 5 | 2 |
| 4 | 4 | 9 | 3 | 8 | 2 | 7 | 1 | 6 | 0 | 5 |
| 5 | 9 | 8 | 7 | 6 | 5 | 4 | 3 | 2 | 1 | 0 |
| 6 | 8 | 5 | 4 | 2 | 0 | 9 | 7 | 5 | 3 | 1 |
| 7 | 6 | 2 | 9 | 5 | 1 | 8 | 4 | 0 | 7 | 3 |
| 8 | 2 | 5 | 8 | 0 | 3 | 6 | 9 | 1 | 4 | 7 |
| 9 | 5 | 0 | 6 | 1 | 7 | 2 | 8 | 3 | 9 | 4 |

Families of permutations have been constructed that have the following properties:
permutations are keyed by a relatively small integer (e.g. system ID);
no two permutations map a same input to a same output
when combined with a simple compression function (e.g. mod) the mappings have good randomness properties.
   These families of permutations produce (very large) Latin squares and, as such, can be viewed as multiplication tables of quasigroups. A Latin square, in this context, is an n×n array filled with n symbols, each occurring exactly once in each row and in each column. A particular switch's mapping is represented by a row or column of the multiplication table. Although the examples illustrated above are based on finite fields, the same methods apply with quasigroups. The key property is that the mapping of flow IDs must be invertible.

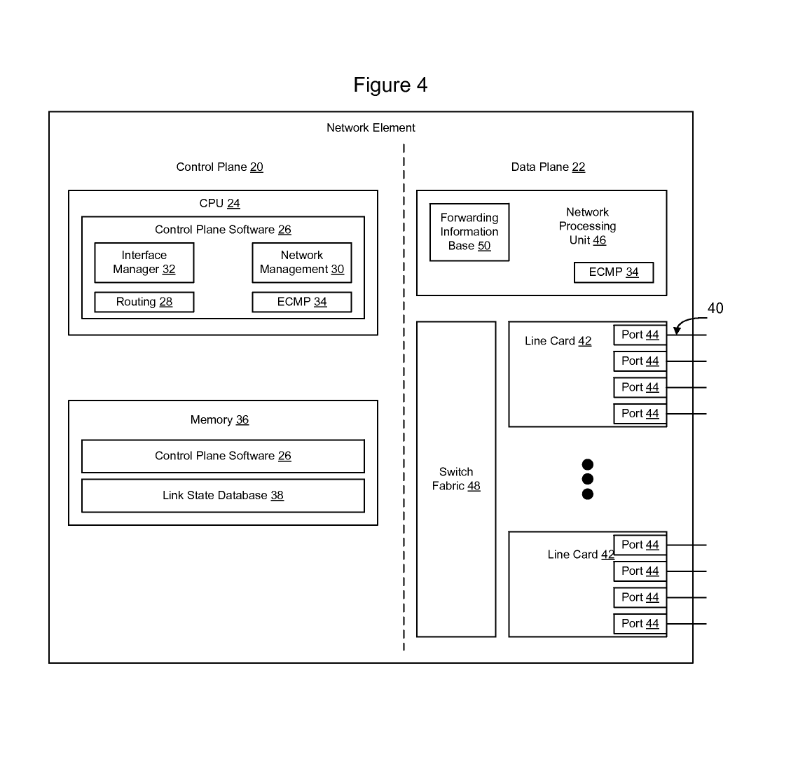

FIG. 4 shows an example network element that may be configured to implement ECMP according to an embodiment. In the example shown in FIG. 4, the network element 10 includes a data plane 20 and a control plane 22. Other architectures may be implemented as well and the invention is not limited to an embodiment architected as shown in FIG. 4. The discussion of the specific structure and methods of operation of the embodiment illustrated in FIG. 4 is intended only to provide one example of how the invention may be used and implemented in a particular instance. The invention more broadly may be used in connection with any network element configured to handle protocol data units on a communications network. The network element of FIG. 4 may be used as an edge network element such as an edge router, a core network element such as a router/switch, or as another type of network element. The network element of FIG. 4 may be implemented on a communication network such as the communication network described above in connection with FIG. 1 or in another type of wired/wireless communication networks.

As shown in FIG. 4, the network element includes a control plane 20 and a data plane 22. Control plane 20 includes one or more CPUs 24. Each CPU 24 is running control plane software 26, which may include, for example, one or more routing processes 28, network operation administration and management software 30, an interface creation/management process 32, and an ECMP process 34. The ECMP process may be run independent of the routing process or may be implemented as part of the routing process. The ECMP process applies the entropy preserving mapping function to select ECPM ports for flows as described above. Alternatively, as described below, the ECMP process may be implemented in the data plane rather than the control plane.

The control plane also includes memory 36 containing data and instructions which, when loaded into the CPU, implement the control plane software 26. The memory further includes link state database 38 containing information about the topology of the network as determined by the routing process 28. The ECMP process 34 uses the information in the LSDB to determine if more than one substantially equal cost path to a destination exists, and then applies the mapping functions described above to assign flows to selected paths.

The data plane 22 includes line cards 42 containing ports 44 which connect with physical media 40 to receive and transmit data. The physical media may include fiber optic cables or electrical wires. Alternatively, the physical media may be implemented as a wireless communication channel, for example using one of the cellular, 802.11 or 802.16 wireless communication standards. In the illustrated example, ports 44 are supported on line cards 42 to facilitate easy port replacement, although other ways of implementing the ports 44 may be used as well.

The data plane 22 further includes a Network Processing Unit (NPU) 46 and a switch fabric 48. The NPU and switch fabric 48 enable data to be switched between ports to allow the network element to forward network traffic toward its destination on the network. Preferably the NPU and switch fabric operate on data packets without significant intervention from the control plane to minimize latency associated with forwarding traffic by the network element. In addition to directing traffic from the line cards to the switch fabric, the NPU also allows services such as prioritization and traffic shaping to be implemented on particular flows of traffic. The line cards may include processing capabilities as well, to enable responsibility for processing packets to be shared between the line cards and NPU. Multiple processing steps may be implemented by the line cards and elsewhere in the data plane as is known in the art. Details associated with a particular implementation have not been included in FIG. 4 to avoid obfuscation of the salient features associated with an implementation of an embodiment of the invention.

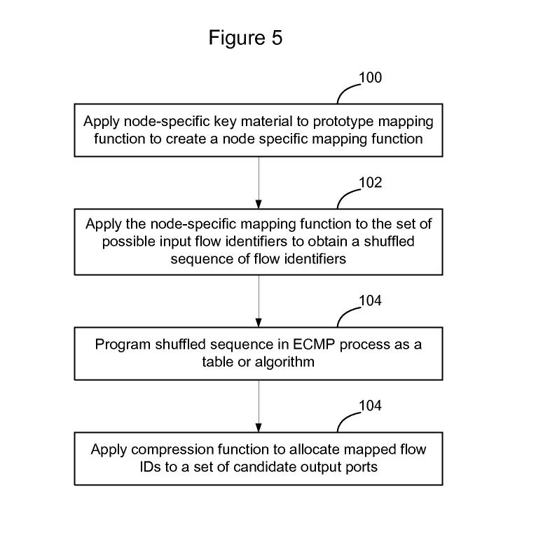

In one embodiment, the computations required to map flow IDs to next hop output ports may be implemented in the data plane. The control plane, in this embodiment, may set up the node-specific function but is not involved in the forwarding decisions. As packets are received and a determination is made that there are multiple equal cost paths to the destination, the packets will be mapped on a per-flow basis to the equal cost paths using the algorithms described above. The particular manner in which responsibility is allocated between the control plane and data plane for the calculations required to implement ECMP will depend on the particular implementation.

Where ECMP is to be implemented, the routing software 28 will use Link State Database 38 to calculate shortest path trees through the network to each possible destination. The forwarding information will be passed to the data plane and programmed into the forwarding information base. The ECMP process 34 will apply the ECMP algorithm to allocate flows to each of the substantially equal cost paths to the destinations. One method for allocating flows of this nature is set forth in FIG. 5. As shown in FIG. 5, the ECMP process applies the node-specific key material to the prototype mapping function to create a node specific mapping function (100). The ECMP process then applies the node-specific mapping function to the set of possible input flow identifiers to obtain a shuffled sequence of flow identifiers (102). This shuffled sequence may be programmed in the ECMP process as a table or as an algorithm (104). Finally, the ECMP process applies a compression function to allocate mapped flow IDs to a set of candidate output ports (106).

The functions described above may be implemented as a set of program instructions that are stored in a computer readable memory and executed on one or more processors on the computer platform. However, it will be apparent to a skilled artisan that all logic described herein can be embodied using discrete components, integrated circuitry such as an Application Specific Integrated Circuit (ASIC), programmable logic used in conjunction with a programmable logic device such as a Field Programmable Gate Array (FPGA) or microprocessor, a state machine, or any other device including any combination thereof. Programmable logic can be fixed temporarily or permanently in a tangible medium such as a read-only memory chip, a computer memory, a disk, or other storage medium. All such embodiments are intended to fall within the scope of the present invention.

It should be understood that various changes and modifications of the embodiments shown in the drawings and described in the specification may be made within the spirit and scope of the present invention. Accordingly, it is intended that all matter contained in the above description and shown in the accompanying drawings be interpreted in an illustrative and not in a limiting sense. The invention is limited only as defined in the following claims and the equivalents thereto.

What is claimed is:

1. A method of performing path selection between substantially equal cost paths by a node in a packet network, the method comprising the steps of:
applying, by the node, a node-specific entropy preserving mapping function keyed with unique key material to a set of possible input flow identifiers to obtain a node-specific shuffled sequence of flow identifiers; and
applying a compression function to allocate the node-specific shuffled sequence of flow identifiers to a set of candidate output ports.

2. The method of claim 1, wherein each node in the packet network independently performs path selection to implement a distributed Equal Cost Multi Path (ECMP) process.

3. The method of claim 2, wherein the distributed ECMP process is implemented such that each node of the packet network will determine, for each packet it receives on an input port, an appropriate output port on which to output the packet for transmission to a next node on a path through the packet network toward a destination.

4. The method of claim 1, node-specific entropy preserving mapping function is fully specified by a prototype entropy-preserving mapping function and the unique key material.

5-9. (canceled)

10. The method of claim 1, wherein the compression function is common to multiple nodes in the packet network.

11. The method of claim 1, wherein the node-specific entropy preserving mapping function is bijective, in which a set of distinct inputs is mapped to a set of distinct outputs having the same number of elements as the set of distinct inputs.

12. The method of claim 11, wherein the mapping of inputs to outputs is one-to-one.

13. The method of claim 1, wherein the node-specific entropy preserving mapping function is injective, in which a set of distinct inputs is mapped to a larger set of possible distinct outputs, in which only a number of distinct outputs corresponding to the number of distinct inputs are used.

14. The method of claim 13, wherein the mapping of inputs to outputs is one-to-one.

15. The method of claim 1, wherein the node-specific entropy preserving mapping function is an exponential-based mapping.

16-21. (canceled)

22. A method of forwarding packets on paths through a packet switching network, each packet having a destination address and a flow identifier, the packet switching network having a plurality of substantially equal cost paths between at least one pair of nodes, each substantially equal cost path having a corresponding candidate output port at each node on the substantially equal cost path, the method comprising, for packets having a destination address having multiple equal costs paths diverging at a node:
selecting candidate output ports at the node by mapping the flow identifier of each packet to one of the candidate output ports for the destination address of the packet, the mapping comprising a first function that is essentially unique to the node such that, for all possible flow identifiers, the function produces a value that is different from values produced by corresponding functions at most or all other network nodes for the same flow identifier, and
where an output set of the function is larger than the number of candidate output ports, the mapping further comprises a compression function which maps the output set of the first function into a set limited to the candidate output ports.

23. The method of claim 22, wherein each node in the packet network independently performs the step of selecting candidate output ports for each packet to implement a distributed Equal Cost Multi Path (ECMP) process.

24. The method of claim 22, wherein the first function is an exponential-based mapping function combined with a linear-congruential mapping function.

25. The method of claim 22, wherein the first function is fully specified by a prototype entropy-preserving mapping function and unique key material.

26. The method of claim 25, wherein the prototype entropy-preserving mapping function is common to multiple nodes in the packet network.

27. The method of claim 25, wherein knowledge of the unique key material and the prototype entropy-preserving mapping function allows selection of an output path for a given input flow ID to be determined so that flow allocation on the packet network is deterministic.

28. The method of claim 22, wherein the first function is bijective, in which a set of distinct inputs is mapped to a set of distinct outputs having the same number of elements as the set of distinct inputs.

29. The method of claim 22, wherein the first function is injective, in which a set of distinct inputs is mapped to a larger set of possible distinct outputs, in which only a number of distinct outputs corresponding to the number of distinct inputs are used.

30. The method of claim 22, wherein the compression function is common to multiple nodes in the packet network.

31. A system for forwarding packets on paths through a packet switching network, each packet having a destination address and a flow identifier, the packet switching network having a plurality of substantially equal cost paths between at least one pair of nodes, each substantially equal cost path having a corresponding candidate output port at each node on the substantially equal cost path, the system comprising:
at least one processor;
at least one network interface operable to couple the processor to the packet switching network; and
at least one memory operable to store instructions for execution by the at least one processor, the instructions being executable for packets having a destination address having multiple equal costs paths diverging at a node:
to select candidate output ports at the node by mapping the flow identifier of each packet to one of the candidate output ports for the destination address of the packet, the mapping comprising a first function that is essentially unique to the node such that, for all possible flow identifiers, the function produces a value that is different from values produced by corresponding functions at most or all other network nodes for the same flow identifier, and
where an output set of the function is larger than the number of candidate output ports, the mapping further comprises a compression function which maps the output set of the first function into a set limited to the candidate output ports.

32-48. (canceled)
